(19) United States
(12) Patent Application Publication
(10) Pub. No.: US 2001/0011863 A1
(43) Pub. Date: Aug. 9, 2001

(54) Shadow mask structure having no wrinkle of shadow mask and cathode-ray tube excellent in screen luminance and color-purity

(75) Inventor: Hiroshi Hasegawa, Shiga (JP)

Correspondence Address: Attention: Norman P. Soloway, HAYES, SOLOWAY, HENNESSEY, GROSSMAN & HAGE, P.C., 175 Canal Street, Manchester, NH, 03101, US

(73) Assignee: NEC Corporation

(21) Appl. No.: 09/776,094

(22) Filed: Feb. 2, 2001

(30) Foreign Application Priority Data
Feb. 4, 2000 (JP) 32714/2000

(51) Int. Cl. H01J 29/80

(52) U.S. Cl. 313/407; 313/402

(57) ABSTRACT

A shadow mask structure to which this invention is applicable comprises a mask frame and a shadow mask. The mask frame is provided with a frame plate and a pair of major sidewalls perpendicularly risen from a pair of major sides of the frame plate. The shadow mask is spanned between top edges of the major sidewalls so as to be tensioned. The shadow mask has an aperture area and a no-aperture area. The no-aperture area is extended on a peripheral region. The shadow mask has a pair of half-etched dent areas formed on the no-aperture area along the pair of minor sides of the shadow mask. The half-etched dent areas have a large number dents.

### BACKGROUND OF THE INVENTION

This invention relates to a shadow mask structure used in a cathode-ray tube (CRT), and particularly relates to a shadow mask structure comprising a mask frame and a shadow mask spanned between top edges of a pair of major sidewalls of the mask frame so as to be tensioned in a minor direction parallel to minor sides of the mask frame.

Generally, such kind of the shadow mask structure comprises a mask frame and a shadow mask attached to the mask frame.

The mask frame is provided with a frame plate and a pair of major sidewalls. The frame plate has a rectangular outline-shape. The major sidewalls are perpendicularly risen from a pair of major sides of the frame plate.

The shadow mask has a rectangular shape corresponding to the frame plate. The shadow mask is spanned between top edges curved upward of the major sidewalls so as to be tensioned in a minor direction parallel to minor sides thereof. The shadow mask has welded areas, an aperture area, and a no-aperture area. The welded areas are seam-welded on the top edges of the major sidewalls. The aperture area is extended on the central rectangular region of the shadow mask. The aperture area has a large number of EB (Electron Beam)-passing apertures. The no-aperture area is extended on a peripheral region of the aperture area.

The shadow mask structure is assembled as described below.

Upper portions of the major sidewalls are forced inwardly by applying predetermined pressures. Consequently, the mask frame is elastic-deformed so that the major sidewalls are leaned inwardly.

Next, the shadow mask is spanned between the top edges of the major sidewalls leaned and the welded areas thereof are seam-welded to the top edges of the major sidewalls. After that, the pressures are released from the major sidewalls. As a result, the shadow mask is tensioned in the minor direction by the mask frame.

A tension-profile of the shadow mask along the major side is peculiar. Namely, the tension-profile of the shadow mask has two peaks at left and right sides thereof.

Furthermore, the tension-profile remarkably sinks at lower slopes of the peaks. In other words, the tension-profile is not continues.

The reason why the tension-profile remarkably sinks at the lower slopes of the peaks is that the rigidity of the shadow mask discontinuously and remarkably changes at a boundary between the aperture and the no-aperture areas.

Because the tension-profile of the shadow mask remarkably sinks at the lower slopes of the peaks as mentioned above, the shadow mask tends to wrinkle between the aperture and the no-aperture areas. When the shadow mask wrinkles between the aperture and the no-aperture areas, electron beams never exactly pass through the EB-passing apertures in the aperture area and never exactly reach to fluorescent elements. Consequently, the CRT comprising this shadow mask structure is reduced in screen luminance and color-purity. Namely, the CRT spoils its commercial value.

### SUMMARY OF THE INVENTION

It is therefore an object of this invention to provide a shadow mask structure having no wrinkles of a shadow mask.

It is another object of this invention to provide a cathode-ray tube comprising the shadow mask structure mentioned above and therefore being excellent in the screen luminance and the color-purity.

The other objects, features, and advantages of this invention will become clear as the description proceeds.

This invention is directed to a shadow mask structure comprising a mask frame and a shadow mask attached to the mask frame. The mask frame is provided with a frame plate having a rectangular outline-shape and a pair of major sidewalls perpendicularly risen from a pair of major sides of the frame plate. The shadow mask has a rectangular shape corresponding to the frame plate and is spanned between top edges of the major sidewalls so as to be tensioned in a minor direction parallel to minor sides thereof. The shadow mask has an aperture area and a no-aperture area. The aperture area is extended on the central rectangular region of the shadow mask and has a large number apertures. The no-aperture area is extended on a peripheral region of the central rectangular region. The shadow mask has a pair of half-etched dent areas formed on the no-aperture area along the pair of minor sides of the shadow mask. The half-etched dent areas have a large number dents.

### BRIEF DESCRIPTION OF THE DRAWINGS

FIG. 1 is a perspective view showing a conventional shadow mask structure;

FIG. 2 is side and plan views of a mask frame of the conventional shadow mask structure shown in FIG. 1;

FIG. 3 is side and plan views of the mask frame of the conventional shadow mask structure shown in FIG. 1 when the mask frame is forced in a minor direction;

FIG. 4A is side views and a plan view of the conventional shadow mask structure shown in FIG. 1 and FIG. 4B is a tension-profile of a shadow mask in a major direction of the conventional shadow mask structure shown in FIG. 1;

FIG. 5 is a perspective view showing a shadow mask structure according to a first embodiment of this invention;

FIG. 6 is partial and enlarged plan view of a shadow mask of the shadow mask structure shown in FIG. 5;

FIG. 7A is side views and a plan view of the shadow mask structure shown in FIG. 5 and FIG. 7B is a tension-profile of a shadow mask in a major direction of the shadow mask structure shown in FIG. 5;

FIG. 8 is a perspective view showing a shadow mask structure according to a second embodiment of this invention; and

FIG. 9A is side views and a plan view of the shadow mask structure shown in FIG. 8 and FIG. 9B is a tension-profile of a shadow mask in a major direction of the shadow mask structure shown in FIG. 8.

### DESCRIPTION OF THE PREFERRED EMBODIMENTS

In order to facilitate an understanding of this invention, description will at first be made with reference to the drawings about conventional shadow mask structure of a type described in the preamble of this specification.

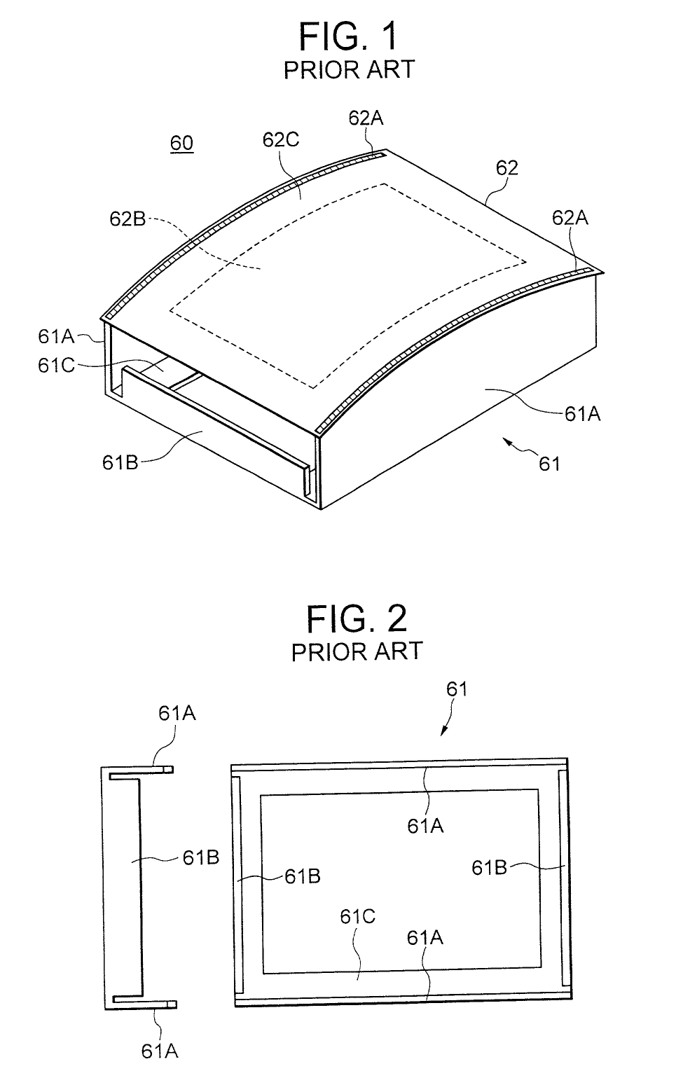

Referring to FIGS. 1 and 2, a conventional shadow mask structure 60 comprises a mask frame 61 and a shadow mask 62 attached to the mask frame 61.

The mask frame 61 is provided with a frame plate 61C, a pair of major sidewalls 61A, and a pair of minor sidewalls 61B. The frame plate 61C has a rectangular outline-shape. The major sidewalls 61A are perpendicularly risen from a pair of major sides of the frame plate 61C. Top edges of the major sidewalls 61A have curvature. The minor sidewalls 61B are perpendicularly risen from a pair of minor sides of the frame plate 61C and are lower in height than that of the major sidewalls 61A. As apparent from FIG. 2, the major and the minor sidewalls 61A and 61B are perpendicularly risen from the frame plate 61C. Each of the minor sidewalls 61B has cut portions at both ends thereof. The effect of the cut portions will later become clear.

The shadow mask 62 has a rectangular shape corresponding to the frame plate 61C. The shadow mask 62 is spanned between the top edges curved upward of the major sidewalls 61A so as to be tensioned in a minor direction parallel to minor sides thereof. The shadow mask 62 has welded areas 62A (shaded in FIG. 1), an aperture area 62B (limited by a dashed line in FIG. 1), and a no-aperture area 62C.

The welded areas 62A are seam-welded on the top edges of the major sidewalls 61A. The aperture area 62B is extended on the central rectangular region of the shadow mask 62. The aperture area 62B has a large number of EB (Electron Beam) -passing apertures. The no-aperture area 62C is extended on a peripheral region of the aperture area 62B.

The shadow mask structure 60 is assembled as described below.

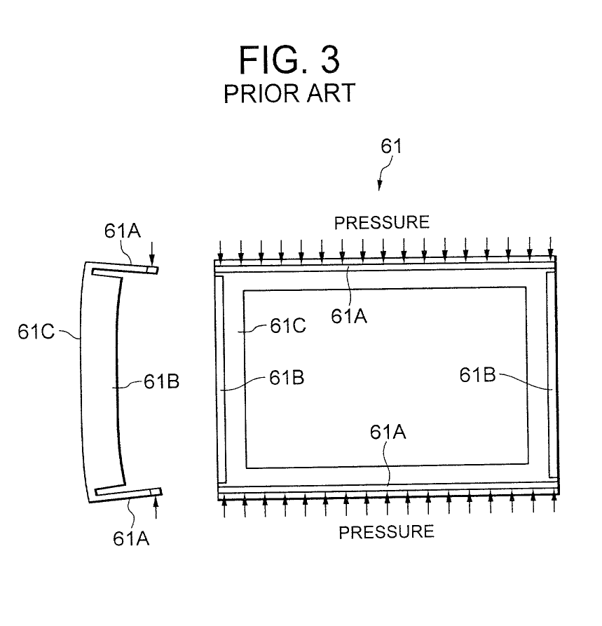

The mask frame 61 is applied pressure. Namely, upper portions of the major sidewalls 61A are forced inwardly by applying predetermined pressures in the minor direction as shown in FIG. 3. Consequently, the mask frame 61 is elastic-deformed so that the minor sidewalls 61B are curved and that the major sidewalls 61A are leaned inwardly as shown in FIG. 3. This is assisted by the cut portions mentioned above. Herein, a distance between the top edges of the major sidewalls 61A is reduced.

Next, the shadow mask 62 is spanned between the top edges of the major sidewalls 61A leaned and the welded areas 62A are seam-welded to the top edges of the major sidewalls 61A. After that, the pressures are released from the major sidewalls 61A.

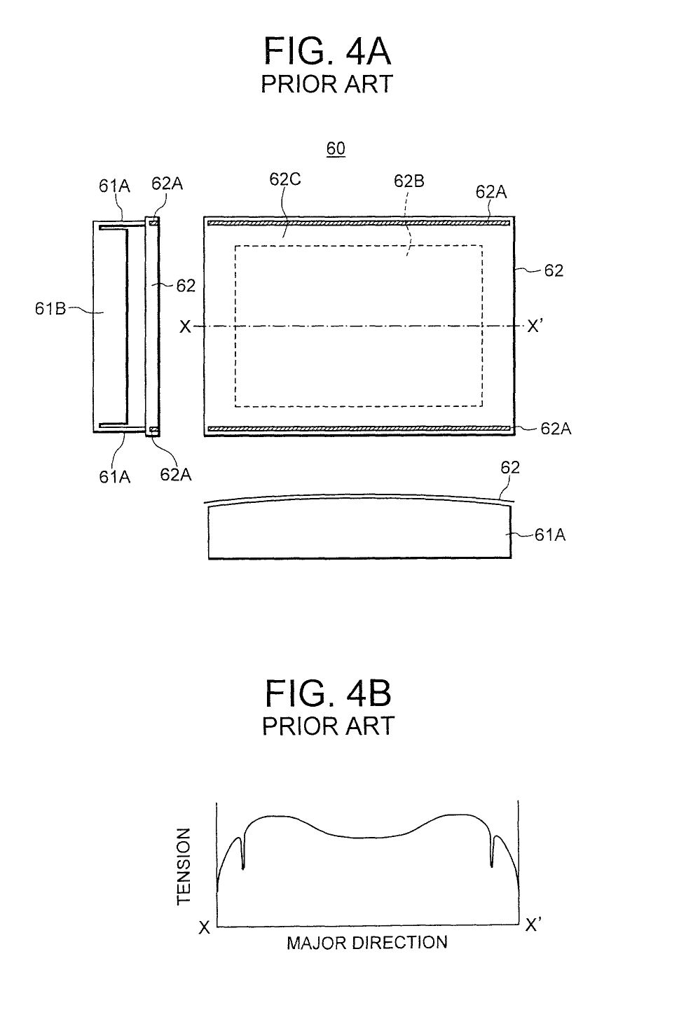

Referring to FIG. 4A, the shape of the mask frame 61 reverts to the state shown in FIG. 2. Namely, the minor sidewalls 61B are straighten up and that the major sidewalls 61A are erected. The shadow mask 62 is tensioned in the minor direction.

The shadow mask 62 is tensioned by the mask frame 61 as shown in FIG. 4B that illustrates a tension-profile of the shadow mask 62 along line X-X′ in FIG. 4A.

As apparent from FIG. 4B, the tension-profile of the shadow mask 62 has two peaks at left and right sides thereof.

Furthermore, the tension-profile remarkably sinks at lower slopes of the peaks. In other words, the tension-profile is not continuos.

The reason why the tension-profile profiles as mentioned above will be described below.

The reason why the tension-profile sinks at left and right ends is that left and right edges of the shadow mask 62 is not restricted (tensioned) by the major or the minor sidewalls 61A or 61B.

Also, the reason why the tension-profile sinks at the center region is that the no-aperture area 62C is enough and efficiently tensioned because of high rigidity thereof while the aperture area 62B is not enough and efficiently tensioned because of low rigidity.

Furthermore, the reason why the tension-profile remarkably sinks at the lower slopes of the peaks is that the rigidity of the shadow mask 62 discontinuously and remarkably changes at a boundary between the aperture and the no-aperture areas 62B and 62C.

Because the tension-profile of the shadow mask 62 remarkably sinks at the lower slopes of the peaks as mentioned above, the shadow mask 62 tends to wrinkle between the aperture and the no-aperture areas 62B and 62C. When the shadow mask 62 wrinkles between the aperture and the no-aperture areas 62B and 62C, electron beams never exactly pass through the EB-passing apertures in the aperture area 62B and never exactly reach to fluorescent elements. This is because the EB-passing apertures shift from regular portion. Consequently, the CRT comprising the shadow mask structure 60 is reduced in screen luminance and color-purity. Namely, the CRT spoils its commercial value.

The reason why the shadow mask 62 wrinkles between the aperture and the no-aperture areas 62B and 62C is not that pressures applied to the major sidewalls may be inconstant. Even if the pressures applied to the major sidewalls are constant, the shadow mask 62 often wrinkles between the aperture and the no-aperture areas 62B and 62C.

Now, preferred embodiments of this invention will be described with reference drawings.

First Embodiment

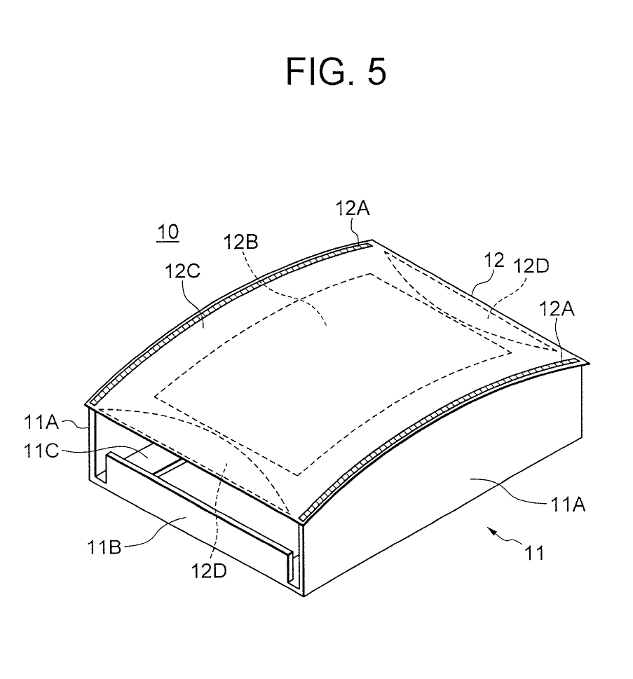

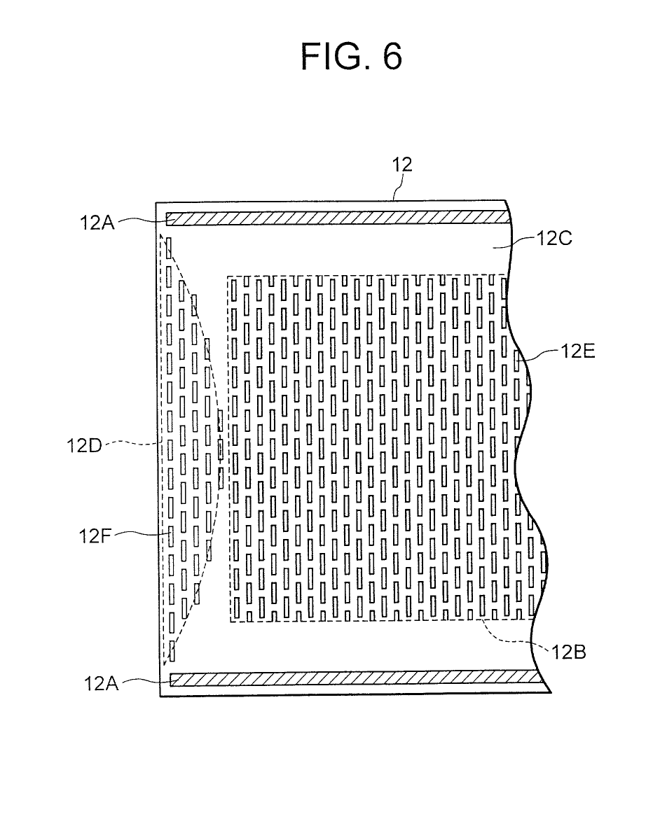

Referring to FIGS. 5, 6, and 7A, a shadow mask structure 10 according to a first embodiment of this invention is applied to a color cathode-ray tube (CRT) having 19 inches of a diagonal size. The shadow mask structure 10 has similar parts designated by similar reference numerals that are illustrated in FIGS. 1 to 4A and 4B. Therefore, description for the similar parts of the shadow mask structure 10 is omitted.

The shadow mask structure 10 comprises a mask frame 11 and a shadow mask 12. The shadow mask structure 10 is 360 mm in major side dimension, 270 mm in minor side dimension, and 43 mm in depth or height dimension.

The mask frame 11 is made by pressing and bending a 13-chromium stainless steel plate having a thickness of 2.5 mm. Instead of the 13-chromium stainless steel plate, a chromium molybdenum steel plate can be used for the mask frame 11. Both of 13-chromium stainless steel and chromium molybdenum steel are high-rigidity metal.

The mask frame 11 is provided with a frame plate 1C, a pair of major sidewalls 11A, and a pair of minor sidewalls 11B. The frame plate 11C has a rectangular outline-shape. The major sidewalls 11A are perpendicularly risen from a pair of major sides of the frame plate 1C.

The shadow mask 12 is made by pressing an Inver plate having a thickness of 0.1 mm. Inver is low-thermal expansion coefficient metal.

The shadow mask 12 has a rectangular shape corresponding to the frame plate 1C. The shadow mask 12 is spanned between top edges curved upward of the major sidewalls 11A so as to be tensioned in a minor direction parallel to minor sides thereof. The shadow mask 12 has welded areas 12A (shaded in FIGS. 5, 6, and 7A), an aperture area 12B (limited by a dashed line in FIGS. 5, 6, and 7A), and a no-aperture area 12C.

The welded areas 12A are seam-welded on the top edges of the major sidewalls 11A. The aperture area 12B is extended on the central rectangular region of the shadow mask 12. The aperture area 12B has a large number of EB (Electron Beam)-passing apertures 12E. The no-aperture area 12C is extended on a peripheral region of the aperture area 12B.

Each of the EB-passing apertures 12E is 0.06 mm in width and 0.26 mm in height. The EB-passing apertures 12E are alternately arranged by 0.25 mm in width pitch and 0.30 mm in height pitch.

Particularly, the shadow mask 12 has a pair of half-etched dent areas 12D (limited by a dashed line in FIGS. 5, 6, and 7A) formed on the no-aperture area 12C along the pair of minor sides of the shadow mask 12. The half-etched dent areas 12D have a large number dents 12F. Each of the dents 12F is 0.06 mm in width, 0.26 mm in height, and 0.06 mm in depth. The dents 12F are arranged by 0.20 mm in width pitch and 0.30 mm in height pitch.

The half-etched dent areas 12D are gradually reduced in width parallel to the minor sides of the shadow mask 12 with heights from the minor sides increased, respectively. Concretely, each of the half-etched dent areas 12D has an outline-shape limited by a quadric curve. Particularly, each of the half-etched dent areas 12D has a central conic curve outline-shape.

The shadow mask structure 10 is assembled as like to the conventional shadow mask structure 60 illustrated in FIGS. 1 to 4A and 4B. Therefore, description of assembling the shadow mask structure 10 is omitted.

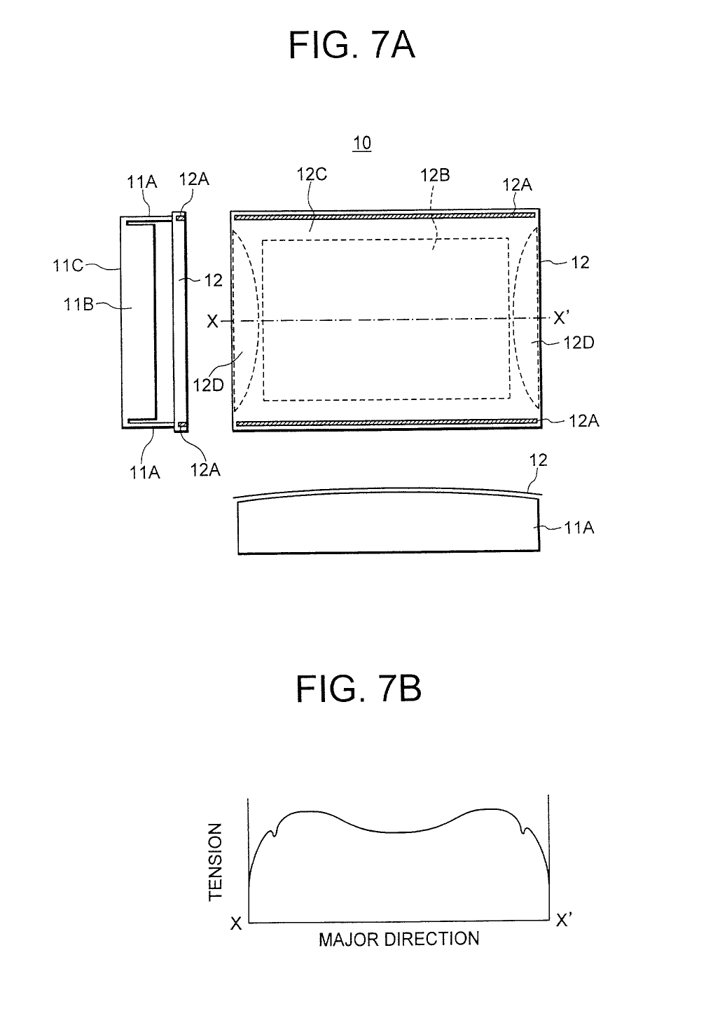

The shadow mask 12 is tensioned by the mask frame 11 as shown in FIG. 7B illustrating a tension-profile of the shadow mask 12 along line X-X′ in FIG. 7A.

As apparent from FIG. 7B, the tension-profile of the shadow mask 12 has two peaks at left and right sides thereof as like to the conventional shadow mask 62.

However, the tension-profile only sinks slightly at lower slopes of the peaks as different from the conventional shadow mask 62. In other words, the tension-profile is substantially continuos.

The reason why the tension-profile only sinks slightly at the lower slopes of the peaks is that the rigidity of the shadow mask 12 continuously changes at a boundary between the aperture and the no-aperture areas 12B and 12C.

The reason why the rigidity of the shadow mask 12 continuously changes at a boundary between the aperture and the no-aperture areas 12B and 12C is that the rigidity of the half-etched dent areas 12D in the no-aperture area 12C is reduced so as to approach the rigidity of the aperture area 12B.

Because the tension-profile of the shadow mask 12 only sinks slightly at the lower slopes of the peaks as mentioned above, the shadow mask 12 does not almost wrinkle between the aperture and the no-aperture areas 12B and 12C. Consequently, the electron beams exactly pass through the EB-passing apertures 12E and exactly reach to fluorescent elements. Thus, the CRT comprising the shadow mask structure 12 performs high screen luminance and excellent color-purity. Namely, the CRT is excellent in commercial value.

Because the dimensions and the pitch of the EB-passing apertures 12E closely affect the CRT in precision-degree, it is difficult to change the EB-passing apertures 12E with taking into consideration the tension-profile of the shadow mask 12 only. On the other hand, because the half-etched dent areas 12D never affect the CRT in precision-degree, it disable to optionally change the dimensions and the pitch of the half-etched dent areas 12D with taking into consideration the tension-profile of the shadow mask 12 only. Namely, the dimensions and the pitch of the half-etched dent areas 12D can be designed so that the shadow mask 12 performs the excellent tension-profile. Therefore, shapes of the half-etched dent areas 12D (arrangement of the dents 12F) may be optionally designed so that the shadow mask 12 performs the excellent tension-profile. However, according to outcome of experiment and study by the inventor of this invention, it is preferable that each of the half-etched dent areas 12D has a central conic curve outline-shape as shown in FIGS. 5, 6, and 7A.

Second Embodiment

In the shadow mask structure 10 according to the first embodiment mentioned above, the shadow mask 12 is directly welded on the mask frame 11. The shadow mask 12 is made of Inver which has low thermal expansion coefficient (approximately 1.2 ppm/° C.) while the mask frame 11 is made of 13-chromium stainless steel or chromium molybdenum steel which has high thermal expansion coefficient (approximately ten times relative to Inver). Furthermore, because the electron beams irradiate the shadow mask 12 when the CRT operates, the shadow mask 12 and the mask frame 11 are increased near 100° C. in temperature.

Therefore, when the CRT operates for a long time or with high screen luminance, the thermal expansion coefficients between the shadow mask 12 and the mask frame 11 may become unconformable to each other. Consequently, the shadow mask 12 may be warped and the color purity may be reduced.

A second embodiment of this invention serves to improve the above-mentioned problem.

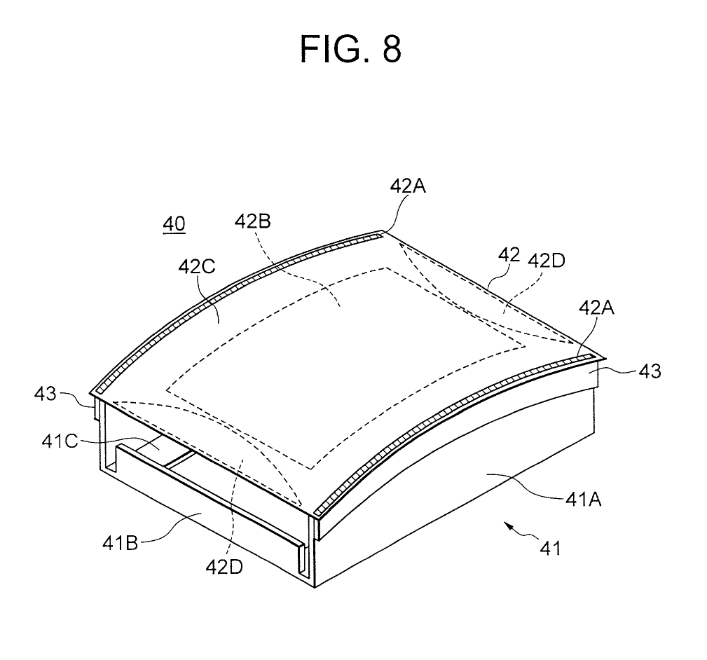

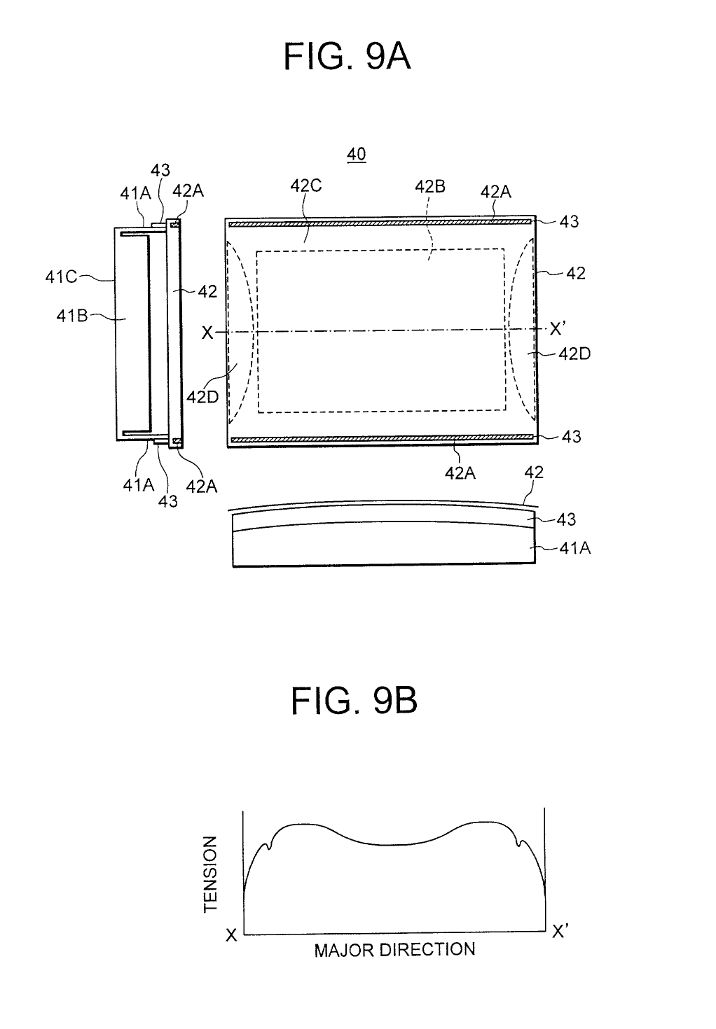

Referring to FIGS. 8 and 9A, a shadow mask structure 40 according to the second embodiment of this invention is also applied to a CRT having 19 inches of a diagonal size. The shadow mask structure 40 of this embodiment has similar parts designated by similar reference numerals that are illustrated in FIGS. 5 to 7 about the first embodiment. Therefore, description for the similar parts of the shadow mask structure 40 is omitted.

The shadow mask structure 40 comprises a mask frame 41 and a shadow mask 42. The shadow mask structure 40 is 360 mm in major side dimension, 270 mm in minor side dimension, and 43 mm in depth or height dimension.

The mask frame 41 is provided with a frame plate 41C, a pair of major sidewalls 41A, and a pair of minor sidewalls 41B. The frame plate 41C has a rectangular outline-shape. The major sidewalls 41A are perpendicularly risen from a pair of major sides of the frame plate 41C.

Particularly, the shadow mask structure 40 further comprises a pair of mask supporting beams 43 attached to upper-outsides of the major sidewalls 41A of the mask frame 41.

The mask frame 41 is made by pressing and bending a 13-chromium stainless steel plate having a thickness of 2.5 mm. Instead of the 13-chromium stainless steel plate, a chromium molybdenum steel plate can be used for the mask frame 41. Both of 13-chromium stainless steel and chromium molybdenum steel are high-rigidity metal.

The mask supporting beams 43 are made essentially of low-thermal expansion coefficient metal. Concretely, each of the mask supporting beams 43 is made from an Inver plate having a thickness of 3.0 mm.

The shadow mask 42 is made by pressing an Inver plate having a thickness of 0.1 mm. Inver is low-thermal expansion coefficient metal.

The shadow mask 42 has a rectangular shape corresponding to the frame plate 41C. The shadow mask 42 is spanned between top edges of mask supporting beams 43 so as to be tensioned in the minor direction thereof. The shadow mask 42 has welded areas 42A (shaded in FIGS. 8 and 9A), an aperture area 42B (limited by a dashed line in FIGS. 8 and 9A), and a no-aperture area 42C.

The welded areas 42A are seam-welded on the top edges of the mask supporting beams 43. The aperture area 42B is extended on the central rectangular region of the shadow mask 42. The aperture area 42B has a large number of EB-passing apertures. The no-aperture area 42C is extended on a peripheral region of the aperture area 42B.

Each of the EB-passing apertures is 0.06 mm in width and 0.26 mm in height. The EB-passing apertures are arranged by 0.25 mm in width pitch and 0.30 mm in height pitch.

The shadow mask 42 has a pair of half-etched dent areas 42D (limited by a dashed line in FIGS. 8 and 9A) formed on the no-aperture area 42C along the pair of minor sides of the shadow mask 42. The half-etched dent areas 42D have a large number dents 42F. Each of the dents 42F is 0.06 mm in width, 0.26 mm in height, and 0.06 mm in depth. The dents 42F are arranged by 0.20 mm in width pitch and 0.30 mm in height pitch.

The half-etched dent areas 42D are gradually reduced in width parallel to the minor sides of the shadow mask 42 with heights from the minor sides increased, respectively. Concretely, each of the half-etched dent areas 42D has an outline-shape limited by a quadric curve. Particularly, each of the half-etched dent areas 42D has a central conic curve outline-shape.

The shadow mask structure 40 is assembled as like to the shadow mask structure 10 of the first embodiment. However, some assembling steps are different from that for the shadow mask structure 10.

The mask supporting beams 43 are seam-welded on the upper-outsides of the major sidewalls 41A of the mask frame 41.

The mask frame 41 is applied pressure through the mask supporting beams 43. Namely, upper portions of the major sidewalls 41A are forced inwardly by applying predetermined pressures through the mask supporting beams 43 in the minor direction. Consequently, the mask frame 41 is elastic-deformed so that the minor sidewalls 41B are curved and that the major sidewalls 41A are leaned inwardly as shown in FIG. 3. Herein, a distance between the top edges of the mask supporting beams 43 is reduced.

Next, the shadow mask 42 is spanned between the top edges of the mask supporting beams 43 leaned and the welded areas 42A are seam-welded to the top edges of the mask supporting beams 43. After that, the pressures are released from the major sidewalls 41A through the mask supporting beams 43.

Referring to FIG. 9A, the shape of the mask frame 41 reverts to the initial state. Namely, the minor sidewalls 41B are straighten up and the major sidewalls 41A are erected. The shadow mask 42 is tensioned in the minor direction.

The shadow mask 42 is tensioned by the mask frame 41 as shown in FIG. 9B of a tension-profile illustrating the shadow mask 42 along line X-X′ in FIG. 9A.

As apparent from FIG. 9B, the tension-profile of the shadow mask 42 has two peaks at left and right sides thereof as like to the conventional shadow mask 62.

However, the tension-profile only sinks slightly at lower slopes of the peaks as like to the shadow mask 12 of the first embodiment. In other words, the tension-profile is substantially continues. The reason why the tension-profile only sinks slightly at the lower slopes of the peaks is that the rigidity of the shadow mask 42 continuously changes at the boundary between the aperture and the no-aperture areas 42B and 42C. The reason why the rigidity of the shadow mask 42 continuously changes at a boundary between the aperture and the no-aperture areas 42B and 42C is that the rigidity of the half-etched dent areas 42D in the no-aperture area 42C is reduced so as to approach the rigidity of the aperture area 42B.

Because the tension-profile of the shadow mask 42 only sinks slightly at the lower slopes of the peaks as mentioned above, the shadow mask 42 does not almost wrinkle between the aperture and the no-aperture areas 42B and 42C. Consequently, the electron beams exactly pass through the EB-passing apertures 42E and exactly reach to fluorescent elements. Thus, the CRT comprising the shadow mask structure 42 performs high screen luminance and excellent color-purity. Namely, the CRT is excellent in commercial value. Because the dimensions and the pitch of the EB-passing apertures 42E closely affect the CRT in precision-degree, it is difficult to change the EB-passing apertures 42E with taking into consideration the tension-profile of the shadow mask 42 only. On the other hand, because the half-etched dent areas 42D never affect the CRT in precision-degree, it is able to optionally change the dimensions and the pitch of the half-etched dent areas 42D with taking into consideration the tension-profile of the shadow mask 42 only. Namely, the dimensions and the pitch of the half-etched dent areas 42D can be designed so that the shadow mask 42 performs the excellent tension-profile. Therefore, shapes of the half-etched dent areas 42D (arrangement of the dents 42F) may be optionally designed so that the shadow mask 42 performs the excellent tension-profile. However, according to outcome of experiment and study by the inventor of this invention, it is preferable that each of the half-etched dent areas 42D has a central conic curve outline-shape as shown in FIGS. 8 and 9A.

Advantages mentioned above of the shadow mask structure 40 are also provided by the shadow mask structure 10. However, the shadow mask structure 40 can provide further advantages.

In the shadow mask structure 40 according to the second embodiment, the shadow mask 42 is indirectly welded on the mask frame 11 through the mask supporting beams 43. The shadow mask 12 and the mask supporting beams 43 are made of Inver which has low thermal expansion coefficient (approximately 1.2 ppm/° C.) while the mask frame 11 is made of 13-chromium stainless steel or chromium molybdenum steel which has high thermal expansion coefficient (approximately ten times relative to Inver).

Consequently, even if the CRT operates for a long time or with high screen luminance, the thermal expansion coefficients between the shadow mask 12 and the mask supporting beams 43 never become unconformable to each other. Thus, the shadow mask 12 is never warped and the color purity is never reduced.

While this invention has thus far been described in conjunction with a few embodiments thereof, it will readily be possible for those skilled in the art to put this invention into practice in various other manners.

What is claimed is:

1. A shadow mask structure comprising a mask frame and a shadow mask attached to said mask frame, said mask frame being provided with a frame plate having a rectangular outline-shape and a pair of major sidewalls perpendicularly risen from a pair of major sides of said frame plate, said shadow mask having a rectangular shape corresponding to said frame plate and being spanned between top edges of said major sidewalls so as to be tensioned in a minor direction parallel to minor sides thereof, said shadow mask having an aperture area and a no-aperture area, said aperture area being extended on the central rectangular region of said shadow mask and having a large number apertures, said no-aperture area being extended on a peripheral region of said central rectangular region;
wherein said shadow mask has a pair of half-etched dent areas formed on said no-aperture area along the pair of minor sides of said shadow mask;
said half-etched dent areas having a large number dents.

2. A shadow mask structure as claimed in claim 1, wherein said half-etched dent areas are gradually reduced in width parallel to said minor sides of said shadow mask with heights from said minor sides increased, respectively.

3. A shadow mask structure as claimed in claim 2, wherein each of said half-etched dent areas has an outline-shape limited by a quadric curve.

4. A shadow mask structure as claimed in claim 3, wherein each of said half-etched dent areas has a central conic curve outline-shape.

5. A shadow mask structure as claimed in claim 1 or 2, wherein said shadow mask is made essentially of low-thermal expansion coefficient metal;
said mask frame being made essentially of high-rigidity metal.

6. A shadow mask structure as claimed in claim 1 or 2, wherein said shadow mask structure further comprises a pair of mask supporting beams attached to upper-outsides of said major sidewalls;
said shadow mask being spanned between top edges of mask supporting beams so as to be tensioned in said minor direction.

7. A shadow mask structure as claimed in claim 6, wherein said mask supporting beams are made essentially of low-thermal expansion coefficient metal.

8. A shadow mask structure as claimed in claim 6, wherein said dents in said half-etched dent areas serve to make rigidities of said aperture and said no-aperture areas equal to each other.

9. A cathode-ray tube comprising a shadow mask structure as claimed in claim 1, 2, 6, or 8.
